(19) United States
(12) Patent Application Publication
(10) Pub. No.: US 2025/0214068 A1
(43) Pub. Date: Jul. 3, 2025

(54) CATALYST WITH VANADIUM TRAP

(71) Applicant: Ketjen Limited Liability Company, Houston, TX (US)

(72) Inventors: Min Li, Houston, TX (US); Edward Lee Foster, Pearland, TX (US)

(73) Assignee: Ketjen Limited Liability Company, Houston, TX (US)

(21) Appl. No.: 19/086,834

(22) Filed: Mar. 21, 2025

Related U.S. Application Data
(62) Division of application No. 17/785,281, filed on Jun. 14, 2022, now abandoned.
(60) Provisional application No. 62/950,698, filed on Dec. 19, 2019.

(51) Int. Cl. B01J 29/85; B01J 23/847; B01J 37/00; B01J 37/04; B01J 37/08; C10G 11/05; C10G 11/18

(52) U.S. Cl. CPC B01J 29/85; B01J 23/8472; B01J 37/0072; B01J 37/04; B01J 37/088; C10G 11/05; C10G 11/18; C10G 2300/1011; C10G 2300/202; C10G 2300/301; C10G 2300/308

(57) ABSTRACT

This invention is directed to a catalyst composition comprising one or more rare earth oxophosphorus components, and process for making such.

### REFERENCE TO RELATED APPLICATIONS

This application is a divisional application of U.S. patent application Ser. No. 17/785,281, filed on Jun. 14, 2022, which is the National Stage of International Patent Application No. PCT/US2020/066091, filed on Dec. 18, 2020, which claims the benefit of U.S. Provisional Patent Application Ser. No. 62/950,698, filed on Dec. 19, 2019.

### TECHNICAL FIELD

This invention relates to catalysts which also function as a vanadium trap.

### BACKGROUND

Vanadium contamination and its detrimental effect on fluid catalytic cracking (FCC) catalysts is known in the art, and it is also known that heavier hydrocarbon feeds generally have a greater content of metals, including vanadium.

Vanadium traps using rare earth metals, particularly lanthanum, have been implemented to address this problem. The vanadium trapping or passivation mechanism is believed to involve binding of vanadium to the rare earth metal.

Improved vanadium traps are desired in the art.

### SUMMARY OF THE INVENTION

This invention provides catalysts which also function as vanadium traps. The catalyst compositions of the invention are typically used in fluid catalytic cracking, and can also be used in deep catalytic cracking and thermafor catalytic cracking. When a rare earth oxophosphorus component is present in the catalyst composition, the detrimental effects of vanadium are minimized. Advantageously, some rare earth oxophosphorus components, especially lanthanum phosphate-based components, may also minimize the detrimental effects of nickel. Another advantage is that in the absence of vanadium, some rare earth oxophosphorus components, in particular at least lanthanum phosphate-based components, do not appear to have a negative effect on catalytic performance.

An embodiment of this invention is a catalyst composition characterized in that the catalyst composition comprises one or more rare earth oxophosphorus components in an amount of about 0.5 wt % to about 20 wt % expressed as rare earth oxophosphorus salt(s), relative to the total weight of the dry ingredients that form the catalyst composition.

Other embodiments of the invention include processes for producing catalyst compositions characterized in that the catalyst compositions comprise one or more rare earth oxophosphorus components in an amount of about 0.5 wt % to about 20 wt % expressed as rare earth oxophosphorus salt(s), relative to the total weight of the dry ingredients that form the catalyst composition.

Another embodiment of this invention comprises contacting a hydrocarbon feed, a bioderived feedstock, or a mixture comprising a hydrocarbon feed and a bioderived feedstock with the catalyst composition comprising one or more rare earth oxophosphorus components.

These and other embodiments and features of this invention will be still further apparent from the ensuing description and appended claims.

### FURTHER DETAILED DESCRIPTION OF THE INVENTION

As used throughout this document, the phrase “expressed as its oxide” and analogous phrases for rare earth metals and phosphorus refer to the amount of rare earth metal or phosphorus, where the numerical value is for the respective oxide(s) of the rare earth metal(s). When more than one rare earth metal is present, the amount refers to the total of all of the rare earth metals present, unless otherwise indicated.

Throughout this document, amounts are reported for the dried catalyst composition, or relative to the other dry ingredients or components of the catalyst composition, unless otherwise specified.

In the catalyst compositions of the invention, the rare earth oxophosphorus components are present in an amount of about 0.5 wt % to about 20 wt %. In some preferred embodiments, the rare earth oxophosphorus components are present in an amount of about 2.5 wt % to about 17 wt %, more preferably about 5 wt % to about 15 wt %, expressed as rare earth oxophosphorus salt(s), relative to the total weight of the dry ingredients that form the catalyst composition. In other preferred embodiments, the rare earth oxophosphorus components are present in an amount of about 1.5 wt % to about 17 wt %, more preferably in an amount of about 2 wt % to about 12 wt %, expressed as rare earth oxophosphorus salt(s), relative to the total weight of the dry ingredients that form the catalyst composition.

The catalyst compositions of the invention typically contain components formed from one or more rare earth oxophosphorus salts, one or more zeolites, one or more aluminum-containing components and/or a silica component, and optionally clay. Other optional ingredients can be present in the catalyst composition.

The rare earth oxophosphorus salts contain rare earth metal cations and oxophosphorus anions, the number of each depending on the number of ions needed to satisfy their valences. The rare earth cation metal can be yttrium or any of the lanthanide series, including lanthanum, cerium, praseodymium, neodymium, promethium, samarium, europium, gadolinium, terbium, dysprosium, holmium, erbium, thulium, and ytterbium; preferred rare earth metals include yttrium, lanthanum, cerium and praseodymium; lanthanum and cerium are more preferred; lanthanum is even more preferred. The oxophosphorus anion of the rare earth salt, more properly called an oxo anion of phosphorus, is an anion containing phosphorus and oxygen. Suitable oxophosphorus anions include phosphate, hypophosphite, phosphite, metaphosphate, and pyrophosphate; preferred is phosphate, PO₄³⁻. Suitable rare earth oxophosphorus salts include yttrium phosphate, lanthanum phosphate, cerium phosphate, praseodymium phosphate, yttrium hypophosphite, lanthanum hypophosphite, cerium hypophosphite, praseodymium hypophosphite, yttrium phosphite, lanthanum phosphite, cerium phosphite, praseodymium phosphite, yttrium metaphosphate, lanthanum metaphosphate, cerium metaphosphate, praseodymium metaphosphate, yttrium pyrophosphate, lanthanum pyrophosphate, cerium pyrophosphate, and praseodymium pyrophosphate. Preferred are yttrium phosphate, lanthanum phosphate, cerium phosphate, and praseodymium phosphate; lanthanum phosphate and cerium phosphate are more preferred, especially lanthanum phosphate.

A variety of zeolites can be present in the catalyst compositions of this invention. Combinations of two or more zeolites can be present in the catalyst composition. Suitable zeolites include faujasite, Y zeolite, ultrastable Y zeolite (USY), HY zeolite, dealuminated Y zeolite, ZSM-5, ZSM-11, ZSM-12, ZSM-20, ZSM-23, ZSM-35, ZSM-38, ZSM-50, beta zeolite, mordenite, MCM-22, MCM-36, MCM-49, MCM-56, ITQ zeolites, silicoaluminophosphate zeolites (SAPOs), aluminophosphate zeolites (ALPOs), and/or rare earth exchanged derivatives thereof. Preferred zeolites include ultrastable Y zeolite and ZSM-5.

When a zeolite is a rare earth exchanged zeolite, the rare earth exchanged zeolite contains about 0.5 wt % to about 20 wt %, preferably about 1 wt % to about 15 wt %, rare earth metal, relative to the total weight of the zeolite.

The total amount of zeolite in the catalyst composition is generally about 5 wt % to about 50 wt %, preferably about 10 wt % to about 40 wt %, more preferably about 15 wt % to about 40 wt %, relative to the total weight of the dry ingredients that form the catalyst composition.

The silica component in the catalyst compositions of the invention can be one or more of an inorganic silicate, an organic silicate, (poly)silicic acid, an organochlorosilane, or colloidal silica. Inorganic silicates include ammonium silicate, lithium silicate, sodium silicate, potassium silicate, magnesium silicate, calcium silicate, strontium silicate, barium silicate, zinc silicate, and phosphorus silicate; mixtures of any two or more of these silicates can comprise the silica component. Suitable organic silicates are compounds containing Si—O—C—O—Si structures, in particular silicones, especially polyorganosiloxanes such as polymethylphenylsiloxane and polydimethylsiloxane. Organochlorosilanes include methyl chlorosilane, dimethyl chlorosilane, trimethyl chlorosilane, and mixtures thereof. The colloidal silicas preferably have an average particle size of about 1 nm to about 500 nm, more preferably, the colloidal silica has an average particle size of about 1.5 nm to about 100 nm, even more preferably about 1.5 nm to about 50 nm. Silica components in the practice of this invention preferably have a low sodium content (e.g., about 1.5 wt % or less). Preferred silica components include sodium-stabilized colloidal silica, ammonium-stabilized colloidal silica, acid-stabilized colloidal silica; mixtures of any two or all three of these types of stabilized colloidal silicas can be used.

The total amount of this silica component in the catalyst composition, when present, is generally about 0.1 wt % to about 20 wt %, preferably about 0.25 wt % to about 15 wt %, more preferably about 0.5 wt % to about 10 wt %, even more preferably about 1 wt % to about 5 wt %, relative to the total weight of the dry ingredients that form the catalyst composition. This amount does not include silica from the zeolite component or other sources, such as clays.

Aluminum-containing components, when present, include alumina, polyaluminum chlorides such as aluminum chlorohydrate, polyaluminum nitrates, and polyaluminum sulfates. Mixtures of two or more aluminum-containing components of the same or different types can be used. Alumina is a preferred aluminum-containing component, and the alumina is in the form of boehmite and/or pseudoboehmite. Boehmite and pseudoboehmite can be in microcrystalline form or in crystalline form. Preferably, the alumina comprises boehmite or comprises boehmite and pseudoboehmite; more preferably, the boehmite is crystalline or microcrystalline and the pseudoboehmite is microcrystalline.

When alumina is the aluminum-containing component, the total amount of boehmite and/or pseudoboehmite in the catalyst composition is generally about 0.1 wt % to about 50 wt %, preferably about 1 wt % to about 45 wt %, more preferably about 5 wt % to about 45 wt %, even more preferably about 10 wt % to about 45 wt %, relative to the total weight of the dry ingredients that form the catalyst composition. This amount does not include alumina from the zeolite component or other sources.

When the aluminum-containing component is a polyaluminum chloride, polyaluminum nitrate, or a polyaluminum sulfate, the total amount of the aluminum-containing component is generally about 1 wt % to about 50 wt %, preferably about 2 wt % to about 25 wt %, more preferably about 5 wt % to about 15 wt %, relative to the total weight of the dry ingredients that form the catalyst composition.

In some preferred embodiments, the catalyst composition comprises both a silica component and an aluminum-containing component.

Optionally, one or more clays can be present in the catalyst composition, and one or more clays is preferably present. Suitable clays for the catalyst composition include kaolin, bentonite, saponite, sepiolite, attapulgite, laponite, laolinite, hectorite, halloysite, montmorillonite, English clay, anionic clays such as hydrotalcite, and heat-treated or chemically treated clays such as meta-kaolin. Preferred clays include kaolin.

When present, the total amount of clay in the catalyst composition is generally about 0.1 wt % to about 70 wt %, preferably 1 wt % to about 40 wt %, more preferably about 5 wt % to about 35 wt %, even more preferably about 10 wt % to about 30 wt %, relative to the total weight of the dry ingredients that form the catalyst composition.

The dry ingredients that form the catalyst composition include the rare earth oxophosphorus salt(s), the aluminum-containing component and/or silica component, clay when present, and any other dry ingredients that are used to make the catalyst composition and remain in the catalyst composition.

In a preferred embodiment, the rare earth oxophosphorus salt is lanthanum phosphate or cerium phosphate, more preferably lanthanum phosphate, the aluminum-containing component is crystalline boehmite and microcrystalline boehmite, and colloidal silica and kaolin are also present. Preferably, the lanthanum phosphate or cerium phosphate is in an amount of about 0.5 wt % to about 20 wt %, more preferably about 1 to about 12 wt % or about 5 to about 15 wt %; the amount of aluminum-containing component is about 0.1 wt % to about 50 wt %, preferably about 10 wt % to about 45 wt %; the colloidal silica is in an amount of 0.1 wt % to about 20 wt %, preferably about 1 wt % to about 5 wt %; and the amount of kaolin is about 0.1 wt % to about 70 wt %, preferably about 10 wt % to about 30 wt %; where all amounts are relative to the total weight of the dry ingredients that form the catalyst composition.

In the processes of this invention, the ingredients, the amounts thereof, and the preferences therefor are as described above.

A process of the invention for producing a catalyst composition is characterized in that one or more rare earth oxophosphorus salts is combined with a catalyst or a component of a catalyst, wherein the rare earth oxophosphorus salt is in an amount of about 0.5 wt % to about 20 wt % expressed as the rare earth oxophosphorus salt(s), relative to the total weight of the dry ingredients. In these processes, the rare earth oxophosphorus salt(s) can be dry blended with the catalyst or a component of a catalyst. When one or more rare earth oxophosphorus salts is combined with a component of a catalyst, that component is then combined with the other component(s) of the catalyst to form the catalyst composition.

One of the processes of the invention for producing a catalyst composition is characterized in that the rare earth oxophosphorus salt(s) is introduced during the process prior to drying, wherein the rare earth oxophosphorus salt(s) is in an amount of about 0.5 wt % to about 20 wt % expressed as the rare earth salt(s), relative to the total weight of the dry ingredients. Spray drying is a preferred drying method.

In another process of this invention for producing a catalyst composition, the first part of the process comprises forming an aqueous slurry by either a) combining ingredients comprising water, a catalyst and the rare earth oxophosphorus salt(s) to form an aqueous slurry, or b) combining ingredients comprising water, one or more zeolites in an amount of about 5 wt % to about 50 wt %; a silica component in an amount of about 0.1 to about 20 wt %; optionally boehmite and/or pseudoboehmite in a total amount of about 0.1 to about 50 wt %, wherein the boehmite and/or pseudoboehmite are microcrystalline and/or crystalline; optionally one or more clays in an amount of about 0.1 to 70 wt %, preferably about 1 to about 40 wt %; and the rare earth oxophosphorus salt(s) in an amount of about 0.5 wt % to about 20 wt %. Preferably, boehmite and/or pseudoboehmite are present in the catalyst composition.

One or more of the ingredients can be dry blended and then combined with water to form an aqueous slurry, and/or one or more of the ingredients can be slurried and then the slurries can be combined, and other dry ingredients can be added to a slurry of another ingredient, and then these slurries are combined. The aqueous slurry is subjected to drying to form the catalyst composition.

In the processes of this invention, the rare earth oxophosphorus salt can be made in situ, for example by introducing a rare earth compound such as an oxide (e.g., lanthanum oxide) and an oxophosphorus acid (e.g., phosphoric acid).

When a silica component is one of the ingredients, it is sometimes prepared shortly before combining with the other ingredients, e.g., when (poly)silicic acid is prepared from sulfuric acid and water glass (sodium silicate).

When boehmite and/or pseudoboehmite is one of the ingredients, it may be peptized by acidification with an acid such as formic acid, acetic acid, propionic acid, nitric acid, or hydrochloric acid, usually prior to combination with the other ingredients of the catalyst composition. The peptization can occur after the boehmite and/or pseudoboehmite have been combined with one or more, or all of, the ingredients of the catalyst composition.

The term “drying” is used throughout this document, but it is recognized that some drying methods are also shaping methods. Suitable drying methods include spray drying, pulse drying, flash drying, pelletizing, extrusion (optionally with kneading), beading, and combinations thereof. A preferred drying method is spray drying. When the catalyst is dried by spray drying, the inlet temperature of the spray dryer preferably ranges from about 200° C. to about 600° C., and the outlet temperature preferably ranges from about 105° C. to about 200° C.

Rare earth oxophosphorus salts, especially lanthanum phosphate (LaPO₄), have high hydrothermal stabilities, and are insoluble in water, so the rare earth oxophosphorus salts are solids in the processes for producing the catalyst compositions.

In preferred processes, the aluminum-containing component is boehmite and/or pseudoboehmite which is peptized by acidification with an acid prior to combination with the other ingredients of the catalyst composition, and the drying method is spray drying. In some of these preferred processes, a silica component is included, and the rare earth oxophosphorus salt is lanthanum phosphate or cerium phosphate, more preferably lanthanum phosphate.

In some embodiments, the process further comprises contacting the catalyst composition with a hydrocarbon feed such as a resid feed or a bioderived feedstock such as vegetable oil, animal fat, or pyrolysis oil, or a mixture comprising a hydrocarbon feed and a bioderived feedstock. When a mixture comprising a hydrocarbon feed and a bioderived feedstock is used, the hydrocarbon feed and the bioderived feedstock can be in any relative proportion to each other, for example from about 1:99 to about 99:1 by weight. In other words, the catalyst composition of the invention is used in a method of cracking of a hydrocarbon feed, a bioderived feedstock, or a mixture comprising a hydrocarbon feed and a bioderived feedstock, which method comprises contacting the catalyst composition with a hydrocarbon feed, a bioderived feedstock, or a mixture comprising a hydrocarbon feed and a bioderived feedstock. In some preferred processes, a hydrocarbon feed is used; in other preferred processes, a bioderived feedstock is used; and in still other preferred processes, a mixture comprising a hydrocarbon feed and a bioderived feedstock is used.

When a catalyst composition is contacted with a hydrocarbon feed, a bioderived feedstock, or a mixture comprising a hydrocarbon feed and a bioderived feedstock, the process is usually fluid catalytic cracking (FCC), deep catalytic cracking (DCC), or thermafor catalytic cracking (or thermofor catalytic cracking, TCC). In an FCC process, the catalyst is generally a fine particulate with about 90 wt % or more of the particles having diameters in the range of about 5 to about 300 microns; in the FCC process, a hydrocarbon feed is gasified and directed upward through a reaction zone, such that the particulate catalyst is entrained and fluidized in the hydrocarbon feed stream, and the catalyst contacts the gaseous hydrocarbon feed, which is cracked by the catalyst; temperatures in the reaction zone are about 400° C. to about 650° C. Fluid catalytic cracking is a preferred process for contacting a hydrocarbon feed with a catalyst composition of the invention.

In addition to the beneficial effect of trapping or passivating vanadium that comes into contact with the catalyst composition, the presence of one or more rare earth oxophosphorus components, particularly lanthanum phosphate-based components, is correlated with an increase in propylene yield from hydrocarbon feeds, as well as a decrease in the amount of coke and dry gas formed, when the catalyst composition is used in fluid catalytic cracking.

The following examples are presented for purposes of illustration, and are not intended to impose limitations on the scope of this invention.

### Example 1

Several catalyst compositions for fluid catalytic cracking were prepared by compounding a zeolite, microcrystalline pseudoboehmite, crystalline boehmite, colloidal silica, and kaolin and then forming an aqueous slurry from the compounded mixture. Before compounding, the microcrystalline boehmite was peptized by acidification with nitric acid. In the inventive runs, lanthanum phosphate (LaPO₄) was added during the compounding step. In the comparative runs, no lanthanum phosphate was present. The zeolite was a rare-earth exchanged Y zeolite containing 12 wt % lanthanum as its oxide, and the colloidal silica had an average particle size of about 10 nm. In the runs containing lanthanum phosphate, the amount of kaolin was reduced (relative to the amount of kaolin in the comparative runs) to accommodate the lanthanum phosphate.

After the slurry was formed, the slurry was transferred into a spray dryer with an inlet temperature of about 500° C. and an outlet temperature of about 120° C. The solids obtained from spray drying were the catalyst compositions. Characteristics of the catalyst composition are summarized in Table 1. Surface area was determined by the Brunauer-Emmet-Teller (BET) N₂ adsorption method. The amounts of rare earth metal and phosphorus in the catalyst composition are reported as the rare earth oxide (e.g., La₂O₃) and phosphorus oxide (P₂O₅) which is conventional in the art.

TABLE 1

| Type | Comparative | | Inventive | | Inventive | | Inventive | |
|---|---|---|---|---|---|---|---|---|
| Run | A | | B | | C | | D | |
| LaPO₄ | 0 | | 5 | wt % | 8 | wt % | 12 | wt % |
| Composition: | | | | | | | | |
| SiO₂ | 34.9 | wt % | 31.3 | wt % | 29.8 | wt % | 27.4 | wt % |
| Al₂O₃ | 60.7 | wt % | 59.4 | wt % | 58.2 | wt % | 56.2 | wt % |
| La₂O₃ | 2.54 | wt % | 5.98 | wt % | 8.00 | wt % | 11.3 | wt % |
| P₂O₅ | 0.03 | wt % | 1.61 | wt % | 2.47 | wt % | 3.83 | wt % |
| Particle size, d₅₀ | 70.0 | μm | 73.5 | μm | 69.1 | μm | 70.0 | μm |
| Surface area | 238 | m²/g | 229 | m²/g | 228 | m²/g | 230 | m²/g |

### Example 2

Another set of catalyst compositions was made in the same way as described in Example 1. Relative amounts of the ingredients and characteristics of the catalyst compositions are summarized in Table 2. Surface area was determined by the Brunauer-Emmet-Teller (BET) N₂ adsorption method. The amounts of rare earth metal and phosphorus in the catalyst composition are reported as the rare earth oxide (e.g., La₂O₃) and phosphorus oxide (P₂O₅) which is conventional in the art.

TABLE 2

| Type | Comparative | | Inventive | |
|---|---|---|---|---|
| Run | E | | F | |
| LaPO₄ | 0 | | 15 | wt % |
| Composition: | | | | |
| SiO₂ | 34.8 | wt % | 26.7 | wt % |
| Al₂O₃ | 60.8 | wt % | 54.7 | wt % |
| La₂O₃ | 2.53 | wt % | 12.9 | wt % |
| P₂O₅ | 0.04 | wt % | 4.43 | wt % |
| Particle size, d₅₀ | 69.9 | μm | 69.5 | μm |
| Surface area | 238 | m²/g | 234 | m²/g |

### Example 3

To samples from a catalyst compositions prepared above, Ni (1000 ppm) and V (3000 ppm) were added by Mitchell impregnation (incipient wetness), and then the metals-impregnated samples were steamed at 788° C., 100% steam, for 10 hours to deactivate them. Each deactivated sample was then analyzed by X-ray fluorescence (XRF) to measure the amount of Ni and V remaining in the deactivated catalyst samples. The surface area of the deactivated catalyst samples was also measured by the Brunauer-Emmet-Teller (BET) N₂ adsorption method to determine the surface area retained in comparison to the surface area of fresh catalysts (non-deactivated and not containing Ni or V)—see Table 1. Results are summarized in Table 3.

TABLE 3

| Type | Comparative | Inventive | Inventive | Inventive | Comparative | Inventive |
|---|---|---|---|---|---|---|
| Run | A | B | C | D | E | F |
| LaPO₄ | 0 | 5 wt % | 8 wt % | 12 wt % | 0 | 15 wt % |
| Ni impregnated | 1022 ppm | 998 ppm | 1022 ppm | 1030 ppm | 951 ppm | 865 ppm |
| V impregnated | 3102 ppm | 3142 ppm | 3097 ppm | 3007 ppm | 3074 ppm | 3086 ppm |
| Surface area | 119 m²/g | 120 m²/g | 123 m²/g | 125 m²/g | 117 m²/g | 124 m²/g |
| Surface area | 50% | 53% | 54% | 54% | 49% | 53% |
| retained | | | | | | |

It can be seen from Table 3 that the inventive samples containing a lanthanum phosphate-based component after V and Ni impregnation and deactivation showed higher retention of surface area than comparative samples that did not contain a rare earth oxophosphorus component, which indicates that vanadium passivation by a rare earth oxophosphorus component, especially a lanthanum phosphate-based component, is effective.

### Example 4

Deactivated samples containing Ni and V prepared as in Example 3 were subjected to Advanced Cracking Evaluation Technology (ACE Technology®) with a resid feed. Characteristics of the resid feed used in the ACE testing are listed in Table 4. Results of the ACE testing are summarized in Table 5. Table 5 shows that at the same catalyst to feed ratio, inventive sample D showed significantly higher conversion than comparative sample A.

TABLE 4

| | | | Distillation | | |
|---|---|---|---|---|---|
| Component | Amount | | properties | | |
| API gravity | 24.3 | | Initial boiling | | 475° F. |
| | | | pt. (IBP) | | (246° C.) |
| Total sulfur | 0.29 | wt % | 5 | wt % | 623 |
| Total nitrogen | 1769 | ppm | 10 | wt % | 678 |
| Basic nitrogen | 478 | ppm | 20 | wt % | 745 |
| Conradson carbon | 3.11 | wt % | 30 | wt % | 789 |
| Aniline point | 205.5° F. | | 40 | wt % | 825 |
| | (96.4° C.) | | | | |
| Ni | 4.2 | ppm | 50 | wt % | 862 |
| V | 4.2 | ppm | 60 | wt % | 906 |

| | | |
|---|---|---|
| 70 | wt % | 956 |
| 80 | wt % | 1019 |
| 90 | wt % | 1106 |
| 95 | wt % | 1170 |

| | |
|---|---|
| Endpoint temp. (EP) | 1263° F. |
| | (684° C.) |

TABLE 5

| Type | Comparative | Inventive | Inventive | Inventive | Comparative | Inventive |
|---|---|---|---|---|---|---|
| Run | A | B | C | D | E | F |
| LaPO₄ | 0 | 5 wt % | 8 wt % | 12 wt % | 0 | 15 wt % |
| Conversion | 75.6 wt % | 75.7 wt % | 76.5 wt % | 77.3 wt % | 76.8 wt % | 77.4 wt % |
| Catalyst: feed, wt. | 5 | 5 | 5 | 5 | 5 | 5 |
| ACE yields at | | | | | | |
| constant conversion | | | | | | |
| (75 wt %): | | | | | | |
| Coke | 10.7 wt % | 10.4 wt % | 9.95 wt % | 9.64 wt % | 9.82 wt % | 8.82 wt % |
| Hydrogen | 0.59 wt % | 0.52 wt % | 0.51 wt % | 0.51 wt % | 0.61 wt % | 0.49 wt % |
| H₂/CH₄ | 0.38 | 0.35 | 0.35 | 0.35 | 0.45 | 0.37 |
| Dry gas | 3.81 wt % | 3.67 wt % | 3.65 wt % | 3.67 wt % | 3.62 wt % | 3.40 wt % |
| Propene | 4.82 wt % | 5.11 wt % | 5.06 wt % | 5.12 wt % | 4.81 wt % | 5.06 wt % |
| C₄ olefins | 6.46 wt % | 6.68 wt % | 6.71 wt % | 6.72 wt % | 6.35 wt % | 6.60 wt % |
| Gasoline | 44.4 wt % | 44.4 wt % | 44.8 wt % | 45.0 wt % | 45.4 wt % | 46.0 wt % |
| LPG¹ | 16.1 wt % | 16.5 wt % | 16.6 wt % | 16.6 wt % | 16.2 wt % | 16.9 wt % |
| LCO² | 16.5 wt % | 16.4 wt % | 16.6 wt % | 16.6 wt % | 16.3 wt % | 16.5 wt % |
| Bottoms | 8.54 wt % | 8.63 wt % | 8.44 wt % | 8.41 wt % | 8.66 wt % | 8.55 wt % |

¹Liquid petroleum gas.
²Light cycle oil.

At a conversion of 75 wt %, lower coke, lower hydrogen, and lower dry gas amounts are seen for the catalyst compositions containing a lanthanum phosphate-based component. The catalyst compositions containing a lanthanum phosphate-based component had overall higher propene, butenes, and liquefied petroleum gas (LPG) yields.

### Example 5

Samples from some of the catalyst compositions prepared above were steamed at 788° C. for 10 hours, and then subjected to Advanced Cracking Evaluation Technology (ACE Technology®) with a resid feed as in Example 4. Results of the ACE testing are summarized in Table 6.

TABLE 6

| Type | Comparative | Inventive | Inventive | Inventive | Comparative | Inventive |
|---|---|---|---|---|---|---|
| Run | A | B | C | D | E | F |
| LaPO₄ | 0 | 5 wt % | 8 wt % | 12 wt % | 0 | 15 wt % |
| Conversion | 80.0 wt % | 79.4 wt % | 79.9 wt % | 78.7 wt % | 80.8 wt % | 80.1 wt % |
| Catalyst: feed, wt | 5 | 5 | 5 | 5 | 5 | 5 |
| ACE yields at 78 | | | | | | |
| wt % conversion: | | | | | | |
| Coke | 6.85 wt % | 6.87 wt % | 6.81 wt % | 6.96 wt % | 6.73 wt % | 6.69 wt % |
| Hydrogen | 0.16 wt % | 0.17 wt % | 0.16 wt % | 0.16 wt % | 0.15 wt % | 0.15 wt % |
| H₂/CH₄ | 0.14 | 0.14 | 0.15 | 0.14 | 0.13 | 0.14 |
| Dry gas | 2.92 wt % | 2.92 wt % | 2.87 wt % | 2.84 wt % | 2.92 wt % | 2.90 wt % |
| Propene | 6.19 wt % | 6.13 wt % | 6.13 wt % | 6.13 wt % | 6.05 wt % | 6.16 wt % |
| C₄ olefins | 7.60 wt % | 7.69 wt % | 7.61 wt % | 7.64 wt % | 7.42 wt % | 7.48 wt % |
| Gasoline | 47.6 wt % | 48.1 wt % | 48.2 wt % | 47.9 wt % | 49.1 wt % | 49.1 wt % |
| LPG¹ | 20.6 wt % | 20.1 wt % | 20.1 wt % | 20.3 wt % | 20.3 wt % | 20.4 wt % |
| LCO² | 14.7 wt % | 14.8 wt % | 14.8 wt % | 14.7 wt % | 14.3 wt % | 14.3 wt % |
| Bottoms | 7.31 wt % | 7.22 wt % | 7.24 wt % | — | 6.69 wt % | 6.69 wt % |

¹ Liquid petroleum gas.
² Light cycle oil.

In the above runs in which nickel and vanadium were not present, the lanthanum phosphate-based component did not interfere with the catalyst performance.

Further embodiments of the invention include, without limitation:

A. A catalyst composition characterized in that the catalyst composition comprises one or more rare earth oxophosphorus components in an amount of about 0.5 wt % to about 20 wt %, expressed as rare earth oxophosphorus salt(s), relative to the total weight of dry ingredients that form the catalyst composition.

B. A catalyst composition as in A comprising one or more zeolites in an amount of about 5 wt % to about 50 wt %; one or more aluminum-containing components in an amount of about 0.1 to about 50 wt % and/or a silica component in an amount of about 0.1 to about 20 wt %, and one or more rare earth oxophosphorus components in an amount of about 0.5 wt % to about 20 wt %, where all amounts are relative to the total weight of dry ingredients that form the catalyst composition.

C. A catalyst composition as in B wherein the aluminum-containing component is a polyaluminum chloride, polyaluminum nitrate, or a polyaluminum sulfate.

D. A catalyst composition as in B wherein the aluminum-containing component is boehmite and/or pseudoboehmite.

E. A catalyst composition as in A comprising an aluminum-containing component formed from a polyaluminum chloride, polyaluminum nitrate, or a polyaluminum sulfate.

F. A catalyst composition as in A comprising an aluminum-containing component formed from boehmite and/or pseudoboehmite.

G. A catalyst composition as in A comprising
one or more zeolites in an amount of about 5 wt % to about 50 wt %;
a silica component in an amount of about 0.1 to about 20 wt %;
boehmite and/or pseudoboehmite in a total amount of about 0.1 to about 50 wt %, wherein the boehmite and/or pseudoboehmite are microcrystalline and/or crystalline;
optionally one or more clays in an amount of about 0.1 to 70 wt %, preferably about 1 to about 40 wt %; and
one or more rare earth oxophosphorus components in an amount of about 0.5 wt % to about 20 wt %,
where all amounts are relative to the total weight of dry ingredients that form the catalyst composition.

H. A catalyst composition as in G wherein boehmite and pseudoboehmite are present.

I. A catalyst composition as in G or H wherein the boehmite is crystalline boehmite.

J. A catalyst composition as in any of A-I wherein the rare earth oxophosphorus components is in an amount of about 2.5 wt % to about 17 wt %, expressed as rare earth oxophosphorus salt(s), relative to the total weight of dry ingredients that form the catalyst composition.

K. A catalyst composition as in any of A-I wherein the rare earth oxophosphorus components is in an amount of about 5 wt % to about 15 wt %, expressed as rare earth oxophosphorus salt(s), relative to the total weight of dry ingredients that form the catalyst composition.

L. A catalyst composition as in any of A-K wherein the rare earth oxophosphorus component is a yttrium, lanthanum, cerium, or praseodymium oxophosphorus component.

M. A catalyst composition as in any of A-K wherein the rare earth oxophosphorus component is a rare earth phosphate-based component.

N. A catalyst composition as in any of A-K wherein the rare earth oxophosphorus component is a lanthanum phosphate-based component.

O. A process for producing a catalyst composition characterized in that one or more rare earth oxophosphorus salts is combined with a catalyst or a component of a catalyst, wherein the rare earth oxophosphorus salt is in an amount of about 0.5 wt % to about 20 wt %, expressed as rare earth oxophosphorus salt(s), relative to the total weight of dry ingredients that form the catalyst composition.

P. A process for producing a catalyst composition characterized in that one or more rare earth oxophosphorus salts is introduced during the process prior to drying, wherein the rare earth oxophosphorus salt is in an amount of about 0.5 wt % to about 20 wt % relative to the total weight of dry ingredients that form the catalyst composition.

Q. A process as in O which comprises combining starting materials for one or more zeolites, one or more aluminum-containing components, and one or more rare earth oxophosphorus salts in an amount of about 0.5 wt % to about 20 wt %, expressed as rare earth oxophosphorus salt(s), relative to the total weight of dry ingredients that form the catalyst composition to form a mixture, and calcining the mixture to form the catalyst composition.

R. A process as in Q wherein the aluminum-containing component is boehmite and/or pseudoboehmite.

S. A process as in Q wherein the aluminum-containing component is a polyaluminum chloride, a polyaluminum nitrate, or a polyaluminum sulfate.

T. A process as in O which comprises
I-a) combining ingredients comprising water, a catalyst and the rare earth oxophosphorus salts to form an aqueous slurry, or
I-b) combining ingredients comprising water,
   one or more zeolites in an amount of about 5 wt % to about 50 wt %,
   one or more aluminum-containing components in an amount of about 0.1 to about 50 wt % and/or a silica component in an amount of about 0.1 to about 20 wt %, and
   one or more rare earth oxophosphorus salts in an amount of about 0.5 wt % to about 20 wt %; or
I-c) combining ingredients comprising
   water,
   one or more zeolites in an amount of about 5 wt % to about 50 wt %;
   a silica component in an amount of about 0.1 to about 20 wt %;
   boehmite and/or pseudoboehmite in a total amount of about 0.1 to about 50 wt %, wherein the boehmite and/or pseudoboehmite are microcrystalline and/or crystalline;
   optionally one or more clays in an amount of about 0.1 to 70 wt %, preferably about 1 to about 40 wt %; and
   one or more rare earth oxophosphorus salts in an amount of about 0.5 wt % to about 20 wt %,
   wherein the boehmite and/or pseudoboehmite is peptized by acidification with an acid,
   to form an aqueous slurry, and
II) drying the aqueous slurry to form the catalyst composition.

U. A process as in K or L further comprising contacting the catalyst composition with a hydrocarbon feed, a bioderived feedstock, or a mixture comprising a hydrocarbon feed and a bioderived feedstock.

V. A process as in U which is fluid catalytic cracking.

W. A process as in Claim O or P wherein boehmite and pseudoboehmite are present.

X. A process as in Claim P or W wherein the boehmite is crystalline boehmite.

Y. A process as in Claim P or T wherein the drying is by spray drying.

Z. A process as in any of O-Y wherein the rare earth oxophosphorus salts is in an amount of about 2.5 wt % to about 17 wt %, expressed as rare earth oxophosphorus salt(s), relative to the total weight of dry ingredients that form the catalyst composition.

AA. A process as in any of O-Y wherein the rare earth oxophosphorus salts is in an amount of about 5 wt % to about 15 wt %, expressed as rare earth oxophosphorus salt(s), relative to the total weight of dry ingredients that form the catalyst composition.

AB. A process as in any of O-AA wherein the rare earth oxophosphorus salt is a lanthanum or cerium oxophosphorus salt.

AC. A process as in any of O-AA wherein the rare earth oxophosphorus salt is a rare earth phosphate.

AD. A process as in any of O-AA wherein the rare earth oxophosphorus salt is yttrium phosphate, lanthanum phosphate, cerium phosphate, or praseodymium phosphate.

AE. A process as in any of O-AA wherein the rare earth oxophosphorus salt is lanthanum phosphate.

AF. A process as in any of O-AE wherein the rare earth oxophosphorus salt is made in situ.

AG. A process as in any of O-AF wherein:
the rare earth oxophosphorus salt is lanthanum phosphate or cerium phosphate, more preferably lanthanum phosphate;
an aluminum-containing component is included, and is crystalline boehmite and microcrystalline boehmite;
a silica component is included, and is colloidal silica; and
kaolin is included as a component.

AH. A process as in AG wherein the colloidal silica is a sodium-stabilized colloidal silica, an ammonium-stabilized colloidal silica, an acid-stabilized colloidal silica, or a mixture of any two or all three of the foregoing.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

That which is claimed is:

1. A process for producing a catalyst composition characterized in that
A) one or more rare earth oxophosphorus salts is combined with a catalyst or a component of a catalyst, wherein the rare earth oxophosphorus salt is in an amount of about 0.5 wt % to about 20 wt %, expressed as rare earth oxophosphorus salt(s), relative to the total weight of dry ingredients that form the catalyst composition, optionally wherein the rare earth oxophosphorus salt is made in situ; or
B) one or more rare earth oxophosphorus salts is introduced during the process prior to drying, wherein the rare earth oxophosphorus salt is in an amount of about 0.5 wt % to about 20 wt % relative to the total weight of dry ingredients that form the catalyst composition, optionally wherein the drying is by spray drying, and optionally wherein the rare earth oxophosphorus salt is made in situ;
wherein the one or more rare earth oxophosphorus salts is combined with the catalyst or a component of the catalyst or introduced to the process in order to trap or passivate vanadium.

2. A process as in claim 1 in A) which comprises combining starting materials for one or more zeolites, one or more aluminum-containing components and/or a silica component, and one or more rare earth oxophosphorus salts in an amount of about 0.5 wt % to about 20 wt %, expressed as rare earth oxophosphorus salt(s), relative to the total weight of dry ingredients that form the catalyst composition to form a mixture, and calcining the mixture to form the catalyst composition.

3. A process as in claim 1 in A) which comprises
I-a) combining ingredients comprising water, a catalyst and the rare earth oxophosphorus salts to form an aqueous slurry; or
I-b) combining ingredients comprising
water,
one or more zeolites in an amount of about 5 wt % to about 50 wt %,
one or more aluminum-containing components in an amount of about 0.1 to about 50 wt % and/or a silica component in an amount of about 0.1 to about 20 wt %, and
one or more rare earth oxophosphorus salts in an amount of about 0.5 wt % to about 20 wt %; or
I-c) combining ingredients comprising
water,
one or more zeolites in an amount of about 5 wt % to about 50 wt %;
a silica component in an amount of about 0.1 to about 20 wt %;
boehmite and/or pseudoboehmite in a total amount of about 0.1 to about 50 wt %, wherein the boehmite and/or pseudoboehmite are microcrystalline and/or crystalline;
optionally one or more clays in an amount of about 0.1 to about 70 wt %; and
one or more rare earth oxophosphorus salts in an amount of about 0.5 wt % to about 20 wt %,
wherein the boehmite and/or pseudoboehmite is peptized by acidification with an acid,
to form an aqueous slurry, and
II) drying the aqueous slurry to form the catalyst composition, optionally wherein the drying is by spray drying.

4. A process as in claim 1 further comprising contacting the catalyst composition with a hydrocarbon feed, a bioderived feedstock, or a mixture comprising a hydrocarbon feed and a bioderived feedstock.

5. A process as in claim 1 wherein in B) an aluminum-containing component is present, and is boehmite and/or pseudoboehmite.

6. A process as in claim 5 wherein boehmite and pseudoboehmite are present.

7. A process as in claim 2 or 3 wherein a silica component is present, and is a sodium-stabilized colloidal silica, an ammonium-stabilized colloidal silica, an acid-stabilized colloidal silica, or a mixture of any two or all three of the foregoing.

8. A process as in claim 1 wherein the rare earth oxophosphorus salts is in an amount of about 2.5 wt % to about 17 wt %, expressed as rare earth oxophosphorus salt(s), relative to the total weight of dry ingredients that form the catalyst composition.

9. A process as in claim 1 wherein the rare earth oxophosphorus salt is a yttrium, lanthanum, cerium, or praseodymium oxophosphorus salt, and/or wherein the rare earth oxophosphorus salt is a rare earth phosphate.

10. A process as in claim 1 wherein the rare earth oxophosphorus salt is yttrium phosphate, cerium phosphate, lanthanum phosphate, or praseodymium phosphate.

11. A process as in claim 1 wherein the rare earth oxophosphorus salt is cerium phosphate or lanthanum phosphate.
